(19) United States
(12) Patent Application Publication
(10) Pub. No.: US 2008/0258630 A1
(43) Pub. Date: Oct. 23, 2008

(54) Light String Lamp Bypass Device

(76) Inventors: Matthew D. Collins, Macomb, MI (US); Rosanna Casciani-Collins, Macomb, MI (US)

Correspondence Address: GREGORY T. ZALECKI, 12900 HALL ROAD, SUITE 400, STERLING HEIGHTS, MI, 48313, US

(21) Appl. No.: 11/737,867

(22) Filed: Apr. 20, 2007

(51) Int. Cl. H05B 37/00

(52) U.S. Cl. 315/122

(57) ABSTRACT

A light string lamp bypass device is comprised of a plug and a conducting member. The plug is shaped and sized to releasably fit within a lamp socket of the light string. The conducting member is attached to the plug. It is shaped, sized and positioned upon the plug such that the conducting member is electrically connected to the socket terminals, is positioned below the top surface of the plug and is positioned between the socket terminals when the plug is inserted into the lamp socket. The impedance of the conducting member substantially matches the impedance of an operating lamp within a lamp socket of the light string. A section of a light string may be darkened by replacing its lamps with the device. A typical use is for the darkening of a section of a light string connecting two decorated bushes.

### BACKGROUND

Light strings are commonly used to provide holiday decoration. They are often used during the Christmas season to decorate Christmas trees, shrubs, other types of trees and building structures.

A typical light string consists of 50 incandescent bulbs or lamps electrically connected in series. The light string is designed for connection to 120 volt rms AC line current. Each bulb is designed to operate with a 2.4 volt potential across its filament. The filament has a resistance of approximately 13.7 ohms when the lamp is operating. A typical light string operates at 175 milliamps and dissipates approximately 21 watts of power. When strings of more than 50 lamps are desired two or more light strings are electrically connected together.

Many modern light string use lamps having a shunt wire across the filament circuit. When the filament of such a lamp burns out a higher voltage across the shunt wire causes it to physically change such that a shunt circuit replaces the filament. This allows the series circuit of the light string to be uninterrupted even though the filament of a lamp has burned out resulting in an open filament circuit. If the lamp did not contain a shunt all of the lamps electrically connected together in series would fail to operate when the filament of one lamp burned out.

The lamps on most light strings are evenly spaced. As a result, areas that are not desired to be the lighted are often lighted anyway when trees, bushes, building structures, or the like are decorated with light strings. For example, two or more exterior bushes are often decorated with one or more light strings. When more than one light string is used, the strings are electrically connected together. The light string traverses the area between the bushes. This area between the bushes then becomes lighted when the light string operates. Many decorators want only the bushes to be lighted and not the area between the bushes. With traditional series connected light sets it is not possible to have an unlighted area between the bushes because this would require the removal of the lamps on the light string in that area. Once one lamp is removed the entire string becomes unlighted because the electrical series connection will have become interrupted. Thus, the decorator has no choice but to keep the area desired to be unlighted lighted. The same situation arises in the decoration of building structures with light strings. Areas desired to be unlighted must remain lighted in order to avoid interruption of the electrical series circuit of the light string.

Although lamps having a shunt wire reduce the problem of having the failure of one lamp cause the failure of the entire light string, the shunt wire lamps do not entirely eliminate the problem. If a lamp falls out or is removed from its socket, the series connection is interrupted and the light string fails to light. If the shunt wire fails to physically transform properly after failure of the filament, the light string fails to light. If a lamp is damaged in such a way that both the filament and the shunt wire are damaged, the light string fails to light.

What is needed is an unlighted device that can be releasably plugged into a lamp socket. The device would complete the series circuit with respect to that particular lamp socket. This would allow an unlighted section of a lamp string to be created. It would also allow an open lamp socket to receive the device and repair the series circuit interruption caused by the open lamp socket.

### SUMMARY

These needs are satisfied by the light string lamp bypass device described herein. The device is intended to be inserted into a lamp socket of a light string. Light strings contain a plurality of lamp sockets. A typical light string contains 50 lamp sockets. Each lamp socket has a pair of terminals. The terminals supply electrical power to a lamp within the socket.

A light string lamp bypass device is comprised of a plug and a conducting member. The plug is shaped and sized to releasably fit within a lamp socket. The conducting member is attached to the plug. The conducting member is shaped, sized and positioned upon the plug such that the conducting member is electrically connected to the socket terminals when the plug is inserted into the lamp socket. When the plug is inserted into the lamp socket the conducting member is positioned below the top surface of the plug.

The primary use of a light string lamp bypass device is in conjunction with an alternating current series connected light string. Within this environment the capacitance and inductance associated with the conducting member are negligible. Thus, the impedance of the conducting member is substantially the same as the resistance of the conducting member. The light string contains a plurality of lamps. It is not unusual for the lamp filament to have a much higher resistance when the lamp is operating, as compared to when the lamp is cold and not operating. When the light string is operating the impedances of the lamps within it are very similar to each other. The impedance (and resistance) of the conducting member is selected to substantially match the impedance of an operating lamp within a lamp socket of the light string. Preferably, the impedance of the conducting member is between 1.5 ohms and 30 ohms.

A cap should be attached to the end of the plug opposite the conducting member. This facilitates the manual removal of the lamp bypass device from a socket into which it has been inserted. The device may be pried out of a lamp socket by inserting one's fingernail underneath the cap.

Two or more light strings may be electrically connected together. This allows a decorator to decorate with one or more light strings. The decorator may desire to darken a section of a lighted light string comprised of a plurality of lamps electrically connected in series. In order to accomplish this the decorator selects a section of the light string for darkening. The lamps within that section are identified. Each lamp identified within the section of the light string to be darkened is replaced with a light string lamp bypass device as described.

### DRAWINGS

These and other features, aspects, and advantages of the present invention will become better understood with regard to the following description, appended claims, and accompanying drawings where:

FIG. 1 is an elevation view of two bushes decorated with a light string showing a darkened section of the light string between the bushes produced by inserting light string lamp bypass devices into the lamp sockets of the light string which are positioned between the bushes.

FIG. 2 is an exploded perspective view of a light string lamp bypass device, lamp socket and lamp socket terminals.

FIG. 3 is an elevation view of the light string lamp bypass device of FIG. 2.

FIG. 4 is a top view of the light string lamp bypass device of FIG. 2.

FIG. 5 is an electrical diagram showing three sets of series connected lamp light strings.

FIG. 6 is another electrical diagram showing two sets of series connected lamp light strings.

FIG. 7 is an elevation view showing the light string lamp bypass device of FIG. 2 inserted into the lamp socket of FIG. 2.

FIG. 8 is an elevation view of an alternate embodiment of a light string lamp bypass device.

FIG. 9 is an exploded perspective view of an alternate embodiment of a light string lamp bypass device, lamp socket and lamp socket terminals.

FIG. 10 is a perspective view of the light string lamp bypass device of FIG. 3, showing an alternate embodiment for the conducting member.

### DESCRIPTION

A light string lamp bypass device 46 is intended to be inserted into a lamp socket 36 of a light string 20. Electrical diagrams of two typical light strings 20 are shown in FIG. 5 and FIG. 6. The light strings 20 receive their power from traditional residential or commercial electrical outlets. A line voltage electrical plug 24 is adapted to be inserted into an electrical outlet. Optionally, the light string 20 has a line voltage electrical socket 26 which is electrically connected to the output of the line voltage electrical plug 24. Light strings 20 may be connected to each other by inserting the line voltage electrical plug 24 of one light string 20 into the line voltage electrical socket 26 of another light string 20 to produce a combined light string. A first line voltage wire 28 and a second line voltage wire 30 exit from the line voltage electrical plug 24. If the light string 20 includes a line voltage electrical socket 26, the appropriate electrical connection is made between the first line voltage wire 28, the second line voltage wire 30 and the line voltage electrical socket 26, as shown in FIG. 6. A series wire 32 branches off from one of the line voltage wires, as shown in FIG. 5 and FIG. 6. The series wire 32 is used to connect a plurality of lamp sockets 36 in series. Each lamp socket 36 has a pair of terminals 38 which are connected to the series wire 32. The terminals 38 supply electrical power to a lamp 42 inserted into the lamp socket 36. Sets of series connected lamps 34 are fabricated by connecting a plurality of lamp sockets 36 and lamps 42 in series, as shown in FIG. 5 and FIG. 6. A typical set of series connected lamps 34 consists of 50 lamps.

FIG. 5 also shows a lamp 42 inserted into one lamp socket 36 and a light string lamp bypass device 46 inserted into another lamp socket 36. The lamp 42 produces light when a voltage is applied across the filament 44 of the lamp 42.

A typical light string 20 consists of 50 2.4 volt lamps 42 connected in series. The typical light string 20 dissipates 21 watts of power and uses 175 milliamps of current when connected to a 120 volt alternating current electrical outlet.

A light string lamp bypass device 46 is comprised of a plug 48 and a conducting member 56.

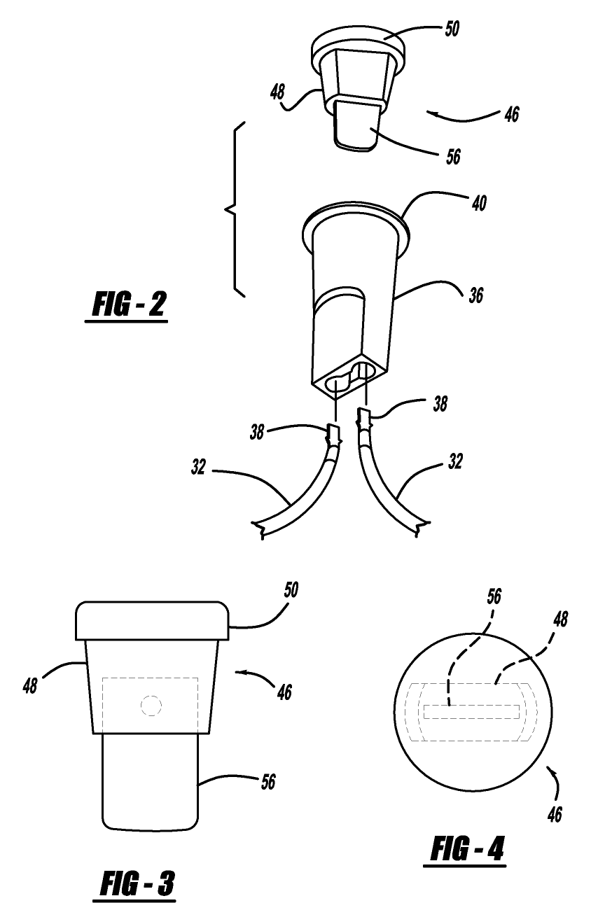

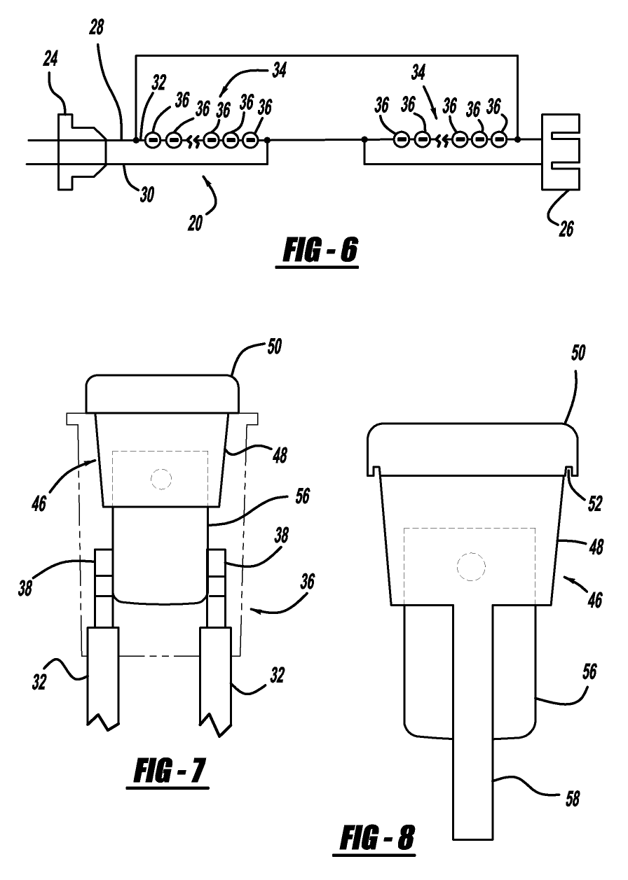

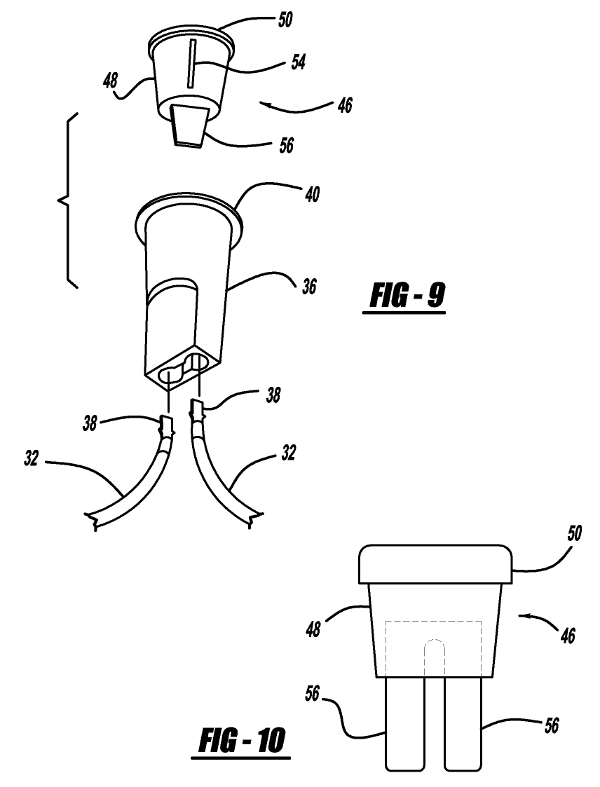

The plug 48 is shaped and sized to releasably fit within a lamp socket 36. Many lamp sockets 36 are tapered. Therefore, a plug 48 intended for use within such a socket 36 should also be tapered. Tapered plugs 48 are shown in FIG. 2, FIG. 3, FIG. 4, FIG. 7, FIG. 8, FIG. 9 and FIG. 10. The plug 48 should be sized and shaped such that it will be securely retained within the lamp socket 36 when pushed therein, yet removable with a manual prying action. A releasable fit may be facilitated by fitting the plug 48 with an interlocking ridge 54, as shown in FIG. 9. With this feature the lamp socket 36 is provided with a matching recess which mates with the interlocking ridge 54.

Preferably, a cap 50 is attached to the end of the plug 48 which is opposite the conducting member, as shown in FIG. 2. The cap 50 is adapted to facilitate the manual removal of the lamp bypass device 46 from a socket 36. This can be accomplished by sizing and shaping the cap 50 such that a person may insert his or her fingernail between the cap 50 and the lamp socket 36 in order to exert a removal force upon the plug 48. Optionally, the cap 50 may be formed with a fin projecting away from the plug 48. The fin would be adapted to facilitate it being manually grasped for removing the light string lamp bypass device 46 from a lamp socket 36.

The light string lamp bypass device 46 and lamp socket 36 may be made waterproof by incorporating the improvements taught by Peng in U.S. Pat. No. 5,700,082, which is incorporated by reference. These improvements include a recess 52 within the underside of the cap 50, as shown in FIG. 8. The recess 52 interlocks with a rim 40 surrounding the opening of the lamp socket 36. The rim 40 is shown in FIG. 2. Additionally, the plug 48 or the conducting member 56 may have a rod 58 attached to it, as shown in FIG. 8. When the plug 48 is pushed into the lamp socket 36, the rod 58 separates the series wires 32 and seals the wire opening holes within the bottom of the lamp socket 36. Preferably, the rod 58 is provided with semicircular grooves at the surfaces where the rod 58 interfaces with the series wires 32.

The preferred material for fabrication of the plug 48 and the cap 50 is plastic. However, it should be clear that many other types of materials may be used. The conducting member 56 should be provided with a hole, as shown in FIG. 3. This will permit a secure bond between the plug 48 and the conducting member 56 when the light string lamp bypass device 46 is fabricated by molding a plastic plug 48 around a conducting member 56.

The purpose of the conducting member 56 is to complete the circuit between the terminals 38 of a lamp socket 36 into which the conducting member 56 is inserted. Ideally, the conducting member is metallic or carbon based. The conducting member 56 is shaped, sized and positioned upon the plug such that the conducting member is electrically connected to the socket terminals 38 when the plug 48 is inserted into the lamp socket 36. The conducting member 56 is positioned below the top surface of the plug 48 and is positioned between the socket terminals 38 when the plug 48 is inserted into the lamp socket 36. These conditions are met by the light string lamp bypass devices 46 shown in FIG. 2, FIG. 3, FIG. 4, FIG. 7, FIG. 8, FIG. 9 and FIG. 10. So long as the conducting member 56 does not pierce through the top of the light string lamp bypass device 46 it is considered to be positioned below the top surface of the plug 46.

The resistance of the conducting member 56 may be controlled by controlling the shape of the conducting member 56 and by controlling the material from which the conducting member 56 is fabricated. For example, different resistances of the conducting member 56 shown in FIG. 10 may be obtained by selecting different heights, widths and thicknesses of the legs and connecting neck of that conducting member 56.

When a light string 20 is operating a plurality of lamps 42 within the light string 20 are operating and are lit. The lit lamps 42 have similar impedances. As described above, in this context the term impedance and resistance are virtually the same. The current draw, power dissipation, total string impedance and individual lamp impedance may be computed for various light string 20 configurations. Assuming that the total impedance is provided by the lamps 42, that the light string 20 is connected to a 120 volt rms alternating current source, and that the string contains 50 lamps 42, the current draw, power dissipation, total string impedance and individual lamp impedance would be as follows:

| current | | | |
|---|---|---|---|
| draw | power dissipation | total string impedance | individual lamp |
| (amps) | (watts) | (ohms) | impedance (ohms) |
| 3 | 360 | 40 | .8 |
| 2 | 240 | 60 | 1.2 |
| 1.2 | 144 | 100 | 2 |
| 1 | 120 | 120 | 2.4 |
| .5 | 60 | 240 | 4.8 |
| .34 | 40.8 | 350 | 7 |
| .30 | 36 | 400 | 8 |
| .175 | 21 | 685.7 | 13.7 |
| .08 | 9.6 | 1500 | 30 |

A typical light string draws 175 milliamps and dissipates 21 watts. This means that the average lamp 42 impedance is 13.7 ohms. Most light strings 20 have lamps with impedances between between 1.5 ohms and 30 ohms. The impedance referred to is the impedance when the lamp 42 is lit and operating, as opposed to the impedance when the lamp 42 is not operating. Preferably, the impedance of the conducting member 56 substantially matches the impedance of an operating lamp 42 within a lamp socket 36 of the light string 20. For 50 lamp 42 light strings 20 operating on 120 volt alternating current the impedance of the conducting member 56 should be, but is not required to be, between 1.5 ohms and 30 ohms. The light string lamp bypass device 46 will operate when the impedance of the conducting member 56 is between 0 and 1.5 ohms. However, if a large number of light string lamp bypass devices 20 with very low impedance conducting members 56 are used on a light string 20, the voltages across the remaining lamps 42 will increase causing an increased light intensity along with a decreased life expectancy of the lamp 42.

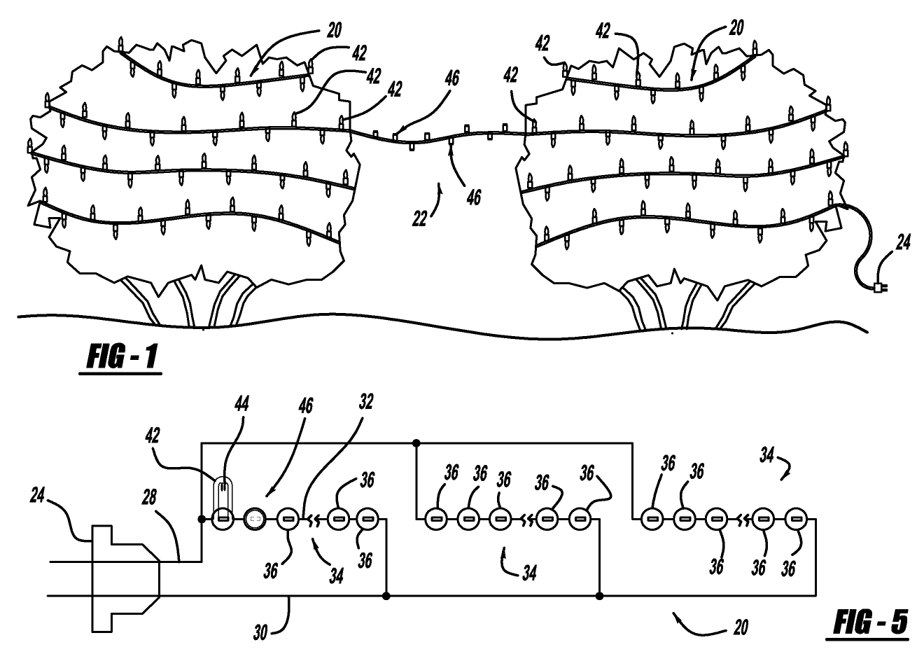

A typical use for light string lamp bypass devices 46 is shown in FIG. 1. A light string 20 is used to decorate two bushes. A darkened section 22 of the light string 20 has been selected. The darkened section 22 is between the bushes. Lamps 42 within the darkened section 22 have been identified and removed from their respective lamp sockets 36. Each lamp 42 within the darkened section 22 of the light string 20 has been replaced with a light string lamp bypass device 46. The light string lamp bypass devices 46 provide continuity to the series lamp circuit. As a result, the lamps 42 on the bushes remain lighted while the darkened section 22 of the light string 20 remains darkened.

A light string lamp bypass device 46 may also be used to fill a lamp socket 36 from which a lamp 42 has fallen out or otherwise been removed. The light string lamp bypass device 46 will allow the remaining lamps 42 to operate by completing the series lamp circuit.

Although the invention has been shown and described with reference to certain preferred embodiments and methods, those skilled in the art undoubtedly will find alternative embodiments and methods obvious after reading this disclosure. With this in mind, the following claims are intended to define the scope of protection to be afforded the inventor, and those claims shall be deemed to include equivalent constructions insofar as they do not depart from the spirit and scope of the present invention. The phrase “consisting essentially of” when used within the claims is meant to exclude other elements having any essential significance to the combination. For example, claims using this phrase are meant to exclude lamp shunts and lamp filaments. The phrase is not meant to exclude elements which do not materially affect the basic and novel characteristics of the claimed invention.

What is claimed is:

1. A light string lamp bypass device consisting essentially of:
(a) a plug shaped and sized to releasably fit within a lamp socket of the light string, said lamp socket having a pair of terminals for supplying electrical power to a lamp within the socket; and
(b) a conducting member attached to the plug, said conducting member being shaped, sized and positioned upon the plug such that the conducting member is electrically connected to the socket terminals when the plug is inserted into the lamp socket.

2. The light string lamp bypass device of claim 1, wherein the impedance of the conducting member substantially matches the impedance of an operating lamp within a lamp socket of the light string.

3. The light string lamp bypass device of claim 1, wherein the impedance of the conducting member is between 1.5 ohms and 30 ohms.

4. The light string lamp bypass device of claim 2, further comprising a cap attached to the end of the plug opposite the conducting member for facilitating the manual removal of the lamp bypass device from a socket into which it has been inserted.

5. The light string lamp bypass device of claim 1, wherein the conducting member is positioned below the top surface of the plug and is positioned between the socket terminals when the plug is inserted into the lamp socket.

6. A light string lamp bypass device for insertion into a lamp socket of the light string, said lamp socket having a pair of terminals for supplying electrical power to a lamp within the socket, said bypass device comprising:
(a) a plug shaped and sized to releasably fit within the lamp socket; and
(b) a conducting member attached to the plug, said conducting member being shaped, sized and positioned upon the plug such that the conducting member is electrically connected to the socket terminals, is positioned below the top surface of the plug and is positioned between the socket terminals when the plug is inserted into the lamp socket.

7. The light string lamp bypass device of claim 6, wherein the impedance of the conducting member substantially matches the impedance of an operating lamp within a lamp socket of the light string.

8. The light string lamp bypass device of claim 6, wherein the impedance of the conducting member is between 1.5 ohms and 30 ohms.

9. The light string lamp bypass device of claim 7, further comprising a cap attached to the end of the plug opposite the conducting member for facilitating the manual removal of the lamp bypass device from a socket into which it has been inserted.

10. A method for darkening a section of a lighted light string comprised of a plurality of lamps electrically connected in series, said method comprising:
(a) selecting a section of the light string for darkening;
(b) identifying the lamps within the section of the light string to be darkened; and
(c) replacing each lamp identified within the section of the light string to be darkened with the light string lamp bypass device of claim 6.

11. The method for darkening a section of a lighted light string comprised of a plurality of lamps electrically connected in series of claim 10, wherein the lamp bypass device is the lamp bypass device of claim 7.
